(19) United States
(12) Patent Application Publication
(10) Pub. No.: US 2010/0243087 A1
(43) Pub. Date: Sep. 30, 2010

(54) System and pump apparatus for processing fluid samples

(75) Inventor: Martin Morrissey, Billerica, MA (US)

Correspondence Address: MILLIPORE CORPORATION, 290 CONCORD ROAD, BILLERICA, MA, 01821, US

(73) Assignee: Millipore Corporation, Billerica, MA (US)

(21) Appl. No.: 12/658,282

(22) Filed: Feb. 10, 2010

Related U.S. Application Data
(60) Provisional application No. 61/209,112, filed on Mar. 3, 2009.

(51) Int. Cl. F04B 43/08; G05D 7/00

(52) U.S. Cl. 137/565.17; 417/478

(57) ABSTRACT

A pump is provided having a disposable bladder and disposable conduits together with check valves that control fluid flow through the bladder and conduits when the bladder is alternately compressed and expanded. The use of disposable conduits and bladder eliminates the need for hygienically regenerating the pump between uses. The pump can be utilized in a fluid delivery system such as tangential flow filtration.

### FIELD OF THE INVENTION

This invention relates to a pump apparatus and a system for processing fluid reagents utilizing disposable fluid conduits. More particularly, this invention relates to such a system and apparatus that utilizes a disposable conduit support system and disposable pump apparatus.

### BACKGROUND OF THE INVENTION

Prior to the present invention, fluid samples have been processed in systems including rigid flow paths such as those formed of stainless steel and working units such as pumps which are connected to zones where unit operations, such as a filtration step or one or more steps where fluid reactions between samples and reagents are effected. The piping design and layout of these systems ensures that the systems minimize hold-up and are easily drained and vented. These features allow the user to maximize the recovery of their highly valuable proteins.

In order to provide greater flexibility in product development and manufacturing, eliminate the probability of cross-contamination between the production runs, eliminate the cost of steam sterilization along with its attendant validation costs, and allow them to defer large capital outlays for plant and equipment dedicated to a specific product, manufacturers have begun to utilize disposable systems of disposable conduits and bags that are assembled and used with each product batch. The disposable systems eliminate the need to hygienically regenerate the system between uses.

At the present time, fluid delivery processes such as tangential flow filtration (TFF) utilize a disposable system including flexible conduits and fluid storage bags. Fluid within these systems is delivered from a storage bag to a tangential flow membrane apparatus and a retentate is recycled to the storage bag until the fluid is satisfactorily filtered. When using these TFF systems, there are optimal conditions of rate of fluid flow and transmembrane pressure. It is desirable to minimize process time which is proportional to rate of fluid flow. Fluid flow is maximized by maximizing transmembrane pressure (TMP).

Presently, peristaltic pumps are utilized to effect fluid flow within a TFF system. However, it is not practical to attain these desired high flow rates, because the currently available peristaltic pumps that are rated for these flows and pressures are not well suited for this application. One problem is that they are prohibitively large in terms of manufacturing floorspace utilization. Another problem is the high initial cost of the pumps makes it economically infeasible to integrate them into a filtration system. Finally, the high power consumption of the pumps, makes their operating costs too high. The peristaltic pumps that are feasible in terms of size, investment, and operating cost can not deliver the high flow rates at the high desired TMPs. It is believed that desired transmembrane pressure is not achieved due to back flow of fluid within the compressed conduit operated on by the rollers or fingers of the peristaltic pump at the desired high flow rate.

Alternative positive displacement pumps now available such as nutation pumps, diaphragm pumps, axial and radial piston pumps, or the like are not desirable since the fluid being pumped directly contacts the interior working portions of the pumps. This, in turn, requires the pump to be hygienically regenerated between uses of the fluid delivery system.

U.S. Pat. No. 4,983,102 discloses a self-enclosing filter pneumatic pumping system which utilizes a disposable bag containing a fluid as well as disposable conduits. The system depends on externally controlled pneumatic sources to achieve a check valve function rather than mechanical check valves. The controller causes air to alternatively close and open them rather than the normal action of a pump. The pneumatically driven pump requires its own compressor, which typically require undesirably large motors that consume large amounts of power.

Accordingly, it would be desirable to provide a positive displacement pump which need not be hygienically regenerated between uses of the pump. In addition, it would be desirable to provide a fluid delivery system having disposable conduits and bags which utilize such a pump. Such a system, including the pump would not require hygienic regeneration between uses and would not require externally controlled pneumatics.

### BRIEF DESCRIPTION OF THE DRAWINGS

FIG. 1 is a schematic view of a tangential flow filtration (TIFF) system utilizing the pump of this invention.

FIG. 2 is a cross-sectional view of an alternative diaphragm pump of this invention at an inlet stroke.

FIG. 3 is a cross-sectional view of the diaphragm pump of FIG. 2 at an exhaust stroke.

FIG. 4 is a cross-sectional view of an alternative diaphragm pump of this invention at an inlet stroke.

FIG. 5 is a cross-sectional view of the diaphragm pump of FIG. 4 at an exhaust stroke.

FIG. 6 is a cross-sectional view of a nutation pump of this invention at the intake stroke of piston 112 and exhaust stroke of piston 110.

FIG. 7 is a cross-sectional view of the nutation pump of FIG. 6 at an exhaust stroke of piston 112 and intake stroke of piston. 110.

### SUMMARY OF THE INVENTION

The present invention provides a pump which includes a disposable flexible bladder and disposable conduits. The bladder or bladders and conduits are integral with the conduits thereby providing a sealed sterile fluid pathway. Representative suitable flexible bladder and conduit materials include silicone, polyethylene, polypropylene, PTFE resin or the like. The pump is provided with a structure which alternatively compresses the bladder and allows the bladder to expand. The alternative compression and expansion of the bladder serves to alternatively open and close mechanical check valves which permit fluid to be pumped within the conduits and bladder from a fluid storage means to a point of use or the fluid storage. The check valves are positioned within a fluid pathway defined by the conduits and bladder.

After use of the pump, the conduits and bladder are disposed while the remaining structure need not be hygienically regenerated since it does not directly contact the fluid.

The present invention also provides a fluid delivery system that utilizes the pump of this invention.

### DESCRIPTION OF SPECIFIC EMBODIMENTS

The pump of this invention can utilize presently available pump structures having a power source and mechanical means connected to the power source that alternatively causes a bladder to expand and compress. Representative suitable pump structures include diaphragm pumps, nutation pumps, axial piston pumps or the like. The bladder is provided with mechanical check valves which alternatively open and close to thereby permit fluid to be pumped into the bladder and then from the bladder. Representative suitable check valves include flap valves, ball check valves, spring loaded check valves or the like.

The pump of this invention can be utilized in a fluid delivery system wherein a fluid is pumped from a fluid storage volume to a point of use or to a second fluid storage volume. Representative systems include buffer/media preparation, clarification, tangential flow filtration (TFF), viral clearance, final till or the like.

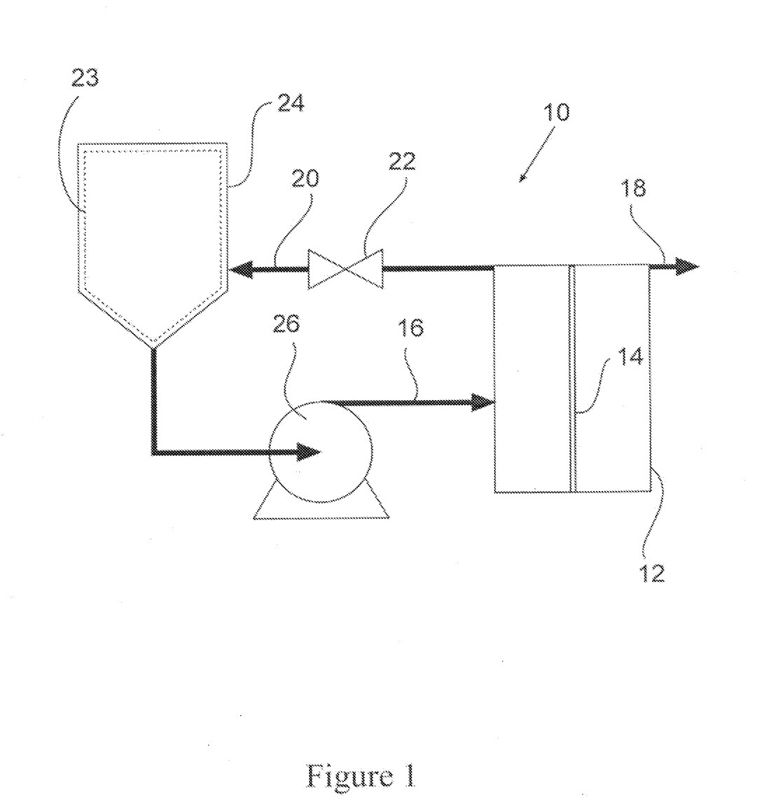

Referring to FIG. 1, a TFF system of this invention is shown. The system 10 includes a filtration step 12 having a TFF filtration cassette 14. Fluid from conduit 16 is passed tangentially over membrane 14 to produce a filtrate 18 directed to a point of use (not shown) or to a fluid storage volume (not shown) and a retentate 20 when valve 22 is open. Typically, about 10% of the fluid directed into contact with membrane 14 becomes filtrate and the remainder comprises retentate. Retentate 20 is directed to fluid storage means 24 containing flexible bag 23. Fluid in fluid storage means 24 is pumped therefrom to filtration step 12 by the pump 26 of this invention until the desired amount of filtrate is produced. Optimum transmembrane pressures of up to 60 psi at flow rates of up to 40 LPM can be achieved when utilizing the pump of this invention in a TFF process.

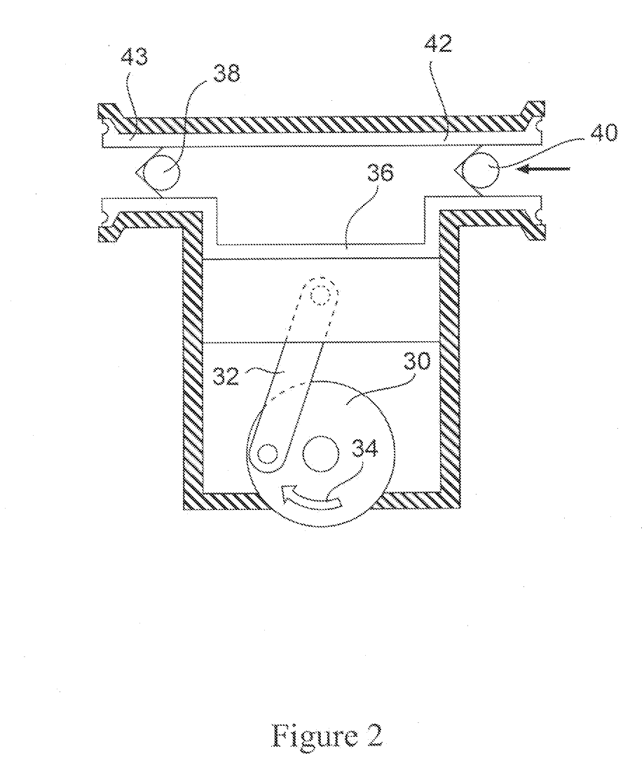

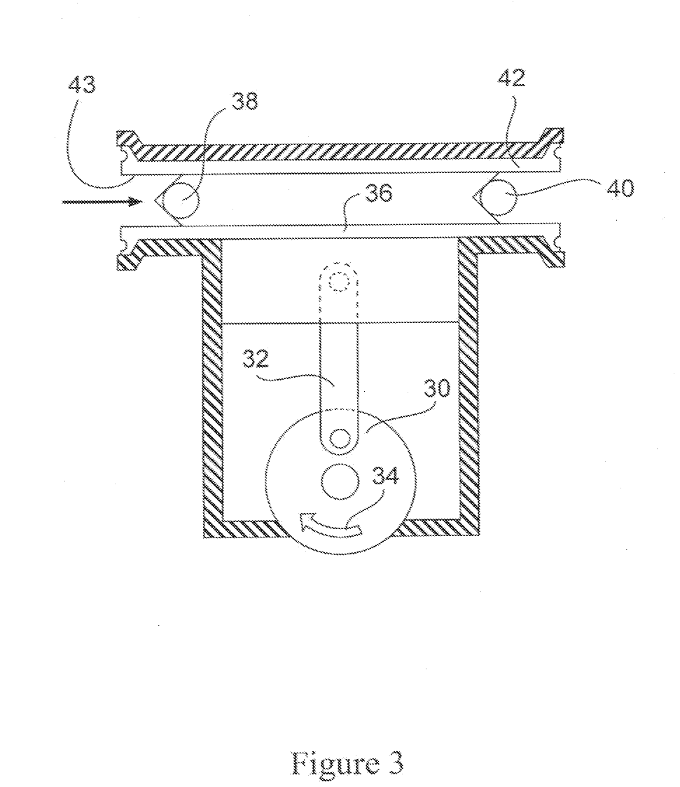

Referring to FIGS. 2 and 3, the pump of this invention is shown in the inlet position (FIG. 2) and the exhaust position (FIG. 3). Motor 30 upon which is mounted arm 32, is rotated in the counterclockwise direction as indicated by arrow 34 to compress bladder 36 (FIG. 3), causing check valve 38 to open and check valve 40 to close thereby directing fluid through conduit 43 to a point of use or to a point of storage. As shown in FIG. 2, motor 30 is rotated to permit expansion of bladder 36 thereby to open check valve 40 and to close check valve 38 thereby to permit fluid to fill bladder 36. This cycle of the motor is repeated to alternately fill bladder 36 and deplete bladder 36 and transfer fluid from a storage volume to a point of use or to a second point of storage. Subsequent to the pumping, the bladder 36 and conduits 43 and 42 are removed together with check valves 38 and 40 and are replaced with conduits, bladders and check valves of the same design to so that the fluid transfer process can be repeated with the same working pump 30 and 32.

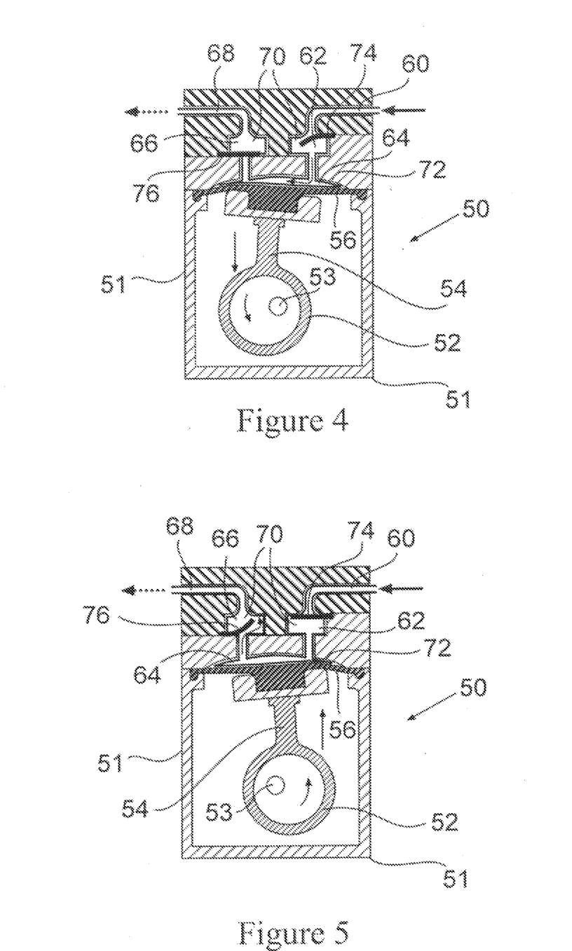

Referring to FIGS. 4 and 5, an alternative diaphragm pump is shown to effect fluid transfer. The pump 50 includes a housing 51, a cam 52 mounted on motor shaft 53 and an arm 54 connected to a diaphragm 56. The fluid delivery system consists of conduits and flexible bladders including inlet conduit 60, secondary bladders 62 and 66, primary bladder 64 and outlet conduit 68. These bladders are housed in first housing 72 and second housing 70. The bladders 62, 66 and 64 together with conduits 60 and 68 are separable from the housings 70 and 72 which permits removal of the primary bladder 64, secondary bladders 62 and 66 and conduits 60 and 68 when the desired fluid transfer is complete without the need for hygienic regeneration of the pump.

During use, at the inlet stroke (FIG. 4), the valve 74 is open to permit entry of fluid into bladder 64 and valve 76 is closed. During the exhaust stroke, valve 74 is closed and valve 76 is open (FIG. 5) thereby to permit, fluid to be transferred to a point of use or to a second storage volume through conduit 68. The cycle is repeated by virtue of the rotation of shaft 53 that drives cam 52 and the check valves 74 and 76 are opened or closed in response to the movement of diaphragm 56 controlled by motor 52. This pump construction permits fluid transfer while avoiding hygienic regeneration of the working pump elements.

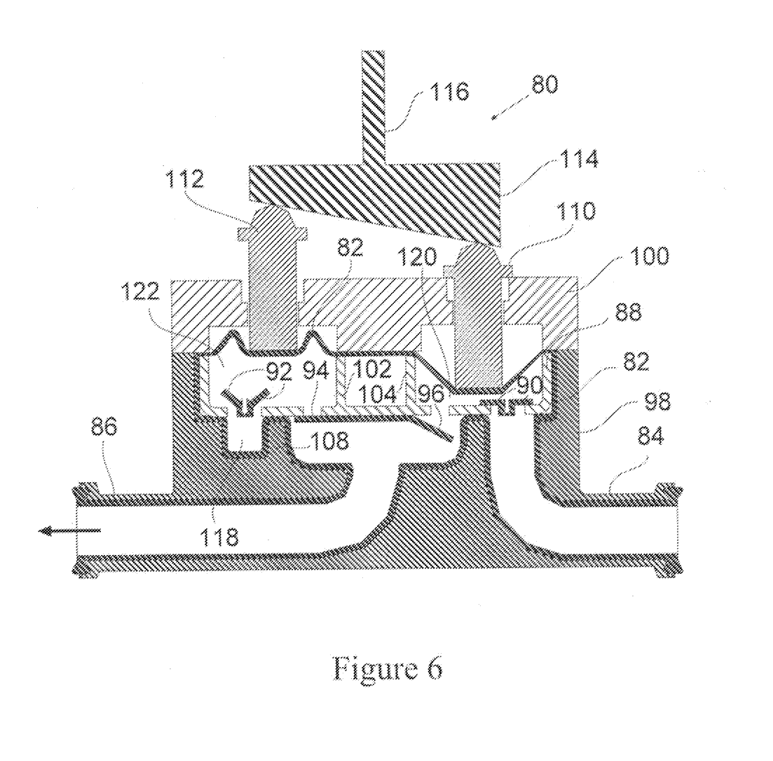

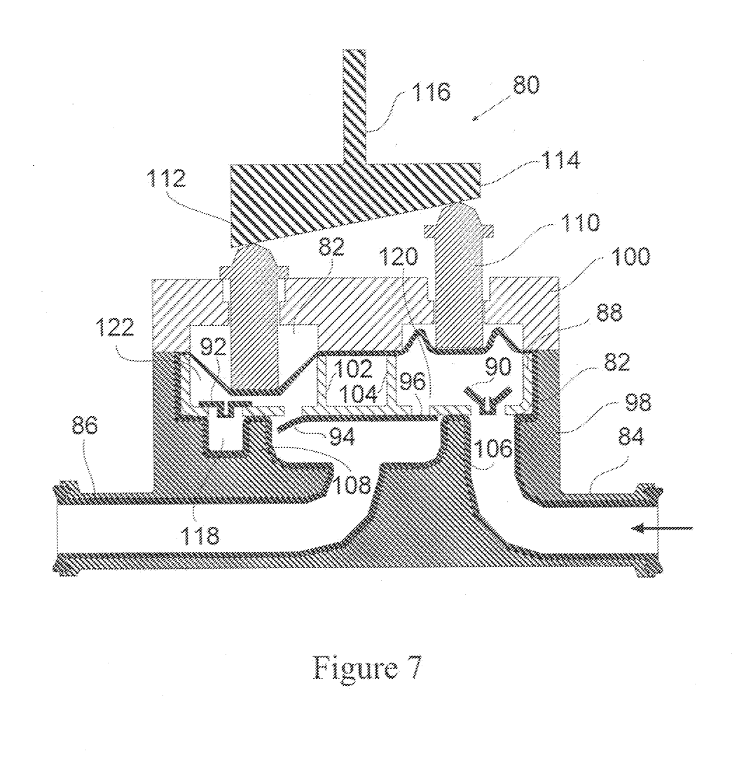

Referring to FIGS. 6 and 7, a nutation pump 80 is shown which includes a bladder 82 connected to conduits 84 and 86. A rigid compartment 88 having check valves 90, 92, 94 and 96 is positioned within bladder 82. The bladder 82, in turn, is positioned within housing 98 having a removable section 100. Bladder 82 extends about the circumference of housing 98. The removable section 100 bears against legs 102 and 104 of compartment 88. Compartment 88 is supported by legs 106 and 108. Pistons 110 and 112 are slideably mounted within section 100. More than two pistons can be utilized, usually three or four. Rotatable swash plate 114 drives the pistons 110 and 112 when shaft 116 is rotated by a motor (not shown). Compartment 118 extends about the circumference of housing 98 and is in fluid communication with conduit 84.

As shown in FIG. 6, fluid in compressed bladder section 120 passes through valve 96 into conduit 86 when piston 110 is positioned as shown. In addition, fluid in compartment 118 passes through valve 92 into expanded bladder section 122 when piston 112 is in the position shown. By operating pump 80 in this manner, fluid passes from conduit 84 into conduit 86.

As shown in FIG. 7, fluid in conduit 84 passes through valve 90 into expanded bladder section 120 when piston 110 is positioned as shown. In addition, fluid in compressed bladder section 122 passes through valve 94 into conduit 86 when piston 112 is in the position shown. By operation in this manner, fluid passes from conduit 84 into conduit 86.

What is claimed,

1. A pump comprising a motor, a disposable bladder, disposable conduits in fluid communication with said bladder, a structure for compressing or expanding said bladder in response to said motor and check valves for controlling fluid flow through said bladder and said conduits.

2. The pump of claim 1 wherein the structure for compressing or expanding said bladder is a diaphragm.

3. The pump of claim 1 wherein the structure means for compressing or expanding said bladder is at least one piston.

4. The pump of claim 1 wherein the structure for compressing or expanding said bladder is a plurality of pistons, each piston adapted to expand or compress a section of said bladder.

5. A fluid delivery system for transporting fluid from a first fluid storage volume to a point of use or to a second fluid storage volume comprising a first fluid storage volume, a second volume selected from the group consisting of a point of use and a second fluid storage volume, one or more fluid conduits connecting the first volume to the second volume, the one or more fluid conduits containing one or more a disposable bladders the one or more disposable bladders having an inlet from the one or more conduits at one location and an outlet from the bladder to the one or more flexible conduits at a second location of the bladder, the inlet and outlet each having a check valve for controlling fluid flow through the one or more bladders and conduits and a pump having a motor and a structure for compressing or expanding the bladder in response to the motor.

6. The system of claim 5 wherein the structure for compressing or expanding said bladder is a plurality of pistons, each piston adapted to expand or compress a section of said bladder.

7. The system of claim 5 wherein the structure for compresing or expanding said bladder is a diaphragm.

8. The system of claim 5 wherein the structure means for compressing or expanding said bladder is at least one piston.

9. The system of claim 5 wherein the check valves are selected from the group consisting of flap valves, ball check valves and spring loaded check valves.

10. The pump of claim 1 wherein the check valves are selected from the group of flap valves, ball check valves and spring loaded check valves.

11. The pump of claim 1 wherein the bladder is formed of a primary bladder and two or more secondary bladders, with at least one secondary bladder on each side of the primary bladder.

12. The system of claim 5 wherein the bladder is formed of a primary bladder and two or more secondary bladders, with at least one secondary bladder on each side of the primary bladder.

13. A disposable assembly for a pump through which fluid moves through the pump comprising a disposable plastic bladder, the bladder having an inlet and an outlet, a flexible conduit attached to each of the inlet and outlet and check valves mounted adjacent the inlet and the outlet.
